(19) United States
(12) Patent Application Publication
(10) Pub. No.: US 2011/0126143 A1
(43) Pub. Date: May 26, 2011

(54) SYSTEM AND METHOD FOR INTERFACING FITNESS EQUIPMENT AND PHYSIOLOGICAL MONITORING

(76) Inventors: MICHAEL D. WILLIAMS, Santa Barbara, CA (US); Brian G. MacDonald, Santa Barbara, CA (US)

(21) Appl. No.: 12/785,347

(22) Filed: May 21, 2010

Related U.S. Application Data
(63) Continuation-in-part of application No. 12/631,690, filed on Dec. 4, 2009.
Application No. 12/631,690 is a continuation-in-part of application No. 12/625,386, filed on Nov. 24, 2009.
Application No. 12/625,386 is a continuation-in-part of application No. 12/624,609, filed on Nov. 24, 2009.

(51) Int. Cl. G06F 3/048

(52) U.S. Cl. 715/771

(57) ABSTRACT

According to one embodiment of the invention, a health and fitness system is provided, comprising: a means for communicating with the equipment; a means for retrieving data from the equipment; a means for transmitting a command to the equipment; and a means for providing a user interface for the equipment, the user comprising: a graphical display for data provided by the equipment, and a user input configured to accept a user selection, wherein the user selection is translated into a command and transmitted to the equipment. In some embodiments, the command comprises one for adjusting a setting of the equipment. In other embodiments, the command comprises one for controlling operation of the equipment. Depending on the embodiment, the equipment with which the embodiment communicates may be include an cycle, a rowing machine, a treadmill, or an elliptical trainer.

### RELATED APPLICATION(S)

This application is a continuation-in-part of and claims the benefit of U.S. patent application Ser. No. 12/631,690, filed Dec. 4, 2009, Ser. No. 12/625,386, filed Nov. 24, 2009, and Ser. No. 12/624,609, filed Nov. 24, 2009, each of which is incorporated herein by reference in their respective entirety.

### FIELD OF THE INVENTION

The present invention relates generally to health and fitness, and more particularly, some embodiments relate to a systems and methods relating to health and fitness equipment and physiological monitoring during use of health and fitness equipment.

### DESCRIPTION OF THE RELATED ART

Advancements in technology have changed the way people approach health and fitness. Over time, useful tools and devices have been developed that provide useful information in attaining and maintaining health and fitness goals. In addition to tracking one's goals, various tools and devices provide real-time information on performance, gauge one's performance with respect to others, and offer tips and suggestions in one's diet and routines. Tools and devices such as heart rate monitors, pace monitors or pedometers, computers on fitness equipment, glucose meters, weight scales, blood pressure cuffs, fitness equipment integrated with sensors, and other health and fitness sensor devices are commonplace in the world of fitness.

Maintaining a record of health and fitness data, such as physiological data (e.g., blood pressure, glucose levels, blood pressure, heart rate, etc.) can be useful in planning and assessing progress regarding physical condition. For example, trends in heart rate, weight, distance, power, speed, calories burned during exercise, cadence, and the other measurements that these devices provide can be helpful in planning future workouts or regimens. Often these systems are equipped with various communications protocols and software methods to allow data transfer from the device to a central database or website.

As such, several of the fitness tools and devices employ interfaces that allow data to be transferred off the device, and stored and/or analyzed for performance purposes. For example, a central module such as a fitness computer can monitor heart rate and caloric expenditure. Such a fitness computer could then interface with a computer, through a wired or wireless connection, allowing it to store and track various fitness performance indicators, such as historical calorie consumption or average heart rate.

Additionally, the tools and devices are not limited to applications. It is commonly understood that one's diet is just as important to achieving and maintaining health and fitness goals as exercise. To that effect, tools and devices have been developed dealing with dieting and eating right. For example, healthy eating applications have been created to offer both advice and recipes for healthy food.

Unfortunately, such conventional tools and devices do not readily interface with existing fitness equipment, especially those that are equipped with their own fitness computer. On the contrary, the tools and devices are usually implemented and used as individual systems, which lack compatibility and interoperability with one another and with the variety of fitness equipment. This makes it both difficult to aggregate data from these tools and devices, and difficult to provide a standard method by which a user can interact with different fitness equipment. The lack of standard interfacing and interoperability not only influences a user's decision on future purchases of such tools and devices, but also serves as an obstacle to widespread use.

### BRIEF SUMMARY OF EMBODIMENTS OF THE INVENTION

According to various embodiments of the invention, systems and methods are provided that interface with fitness (i.e., exercise) equipment or personal transportation equipment (e.g., ebike) and track and manage health and fitness data, such as physiological data (e.g., heart rate, cadence, blood pressure, respiration, body temperature, body position, body motion, speed, acceleration, power output, etc.). For example, according to one embodiment of the invention, a health and fitness system is provided for equipment configured for exercise or personal transportation, comprising: a means for communicating with the equipment; a means for retrieving data from the equipment; a means for transmitting a command to the equipment; and a means for providing a user interface for the equipment, the user interface comprising a graphical display of data provided by the equipment, and a user input to accept a user selection for the equipment to be transmitted as a command to the equipment. In some embodiments, the command comprises one for adjusting a setting of the equipment (e.g., resistance, assistance, inclination, speed, time intervals, etc.). In other embodiments, the command comprises one for controlling operation of the equipment. In some embodiments, the command is transmitted according to either manually inputs to the health and fitness system by a user, or automatically based on physiological data from a user (i.e., measurements of user performance), a dynamic workout plan that uses physiological data to adjust the plan, or a static workout plan. For example, for those embodiments that utilize physiological data when transmitting a command, a health and fitness system may automatically control the equipment settings/parameters by using physiological data obtained through a personal area network (PAN) of sensors, which may be wired or wireless (e.g., short-range wireless). In such an embodiment, the parameters of the machine may be controlled based on comparing the current physiological data to preset threshold values, or using the current physiological data in an algorithm.

Depending on the embodiment, the equipment with which the embodiment communicates may include an cycle, a rowing machine, a treadmill, an elliptical trainer, or a power assisted bicycle. For example, a power assisted bike (commonly referred to as an ebike), a type of personal transport, usually comprises a motor installed on the bike drive train, and a throttle control which controls the level of power assist provided by the motor. With a system in accordance with one embodiment of the invention, the level of power assistance provided by the motor may be adjusted by the health and fitness system according to the physiological data (e.g., heart rate of the rider) of the rider being collected by the system. By doing so, the health and fitness system can help prevent the rider from over exerting themselves during a ride. Additionally, as noted above, the methodology by which an embodiment adjusts or controls a piece of equipment according to the physiological data may vary. For example, some embodiments may adjust equipment settings/parameters by comparing physiological data against thresholds, where each threshold is either preset or calculated by a software algorithm.

In certain embodiments, the means for communicating with the equipment communicates with a central module (e.g., fitness computer) on the equipment. The data from the equipment may relate to operation of the equipment, or may be data related to health and fitness (e.g., physiological data, or exercise session data). Those embodiments where the data is health and fitness data may further comprise a means for logging the health and fitness data. Additional embodiments further comprise a means for retrieving health and fitness data from another health and fitness data source. The health and fitness data received from the equipment may include physiological data relating to the user of the equipment. The health and fitness data received from fitness equipment may also include exercise session data relating to the overall workout, such as the fitness equipment settings at different times during an exercise session.

For particular embodiments, the system further comprises a means for sharing the health and fitness data with a remote computing device or database on a server. In some such embodiments, the means for sharing health and fitness data may include interacting with a personal trainer website (e.g., virtual personal trainer), a medical website, or a practice management software. For other such embodiments, the remote computing device with which the health and fitness data is shared may be on the Internet.

In further embodiments, the means for communicating with the equipment computer may do so by communicating with a sensor attached to the equipment. In other embodiments, the means for communicating with the equipment computer may do so by communicating with a central module on the equipment.

Additional embodiments may further comprise a means for creating or receiving a structured workout. Examples of structured workouts include (i) zone workouts, which define training peaks and time durations for a user to follow when exercising using certain exercise equipment, such as an elliptical machine; and (ii) workouts having a pattern of one or more exercises pre-defined according to physiological parameters (e.g., blood pressure, cadence, heart rate, etc.). Such structured workouts may be defined by a user or, alternatively, provided by a personal trainer or coach (e.g., virtual coach via the Internet). In some such embodiments, the health and fitness system may transmit commands to the equipment according to the structured workout. The system may further comprise a means for generating a second graphical representation of the structured workout. Further, in some such embodiments, the first graphical representation of the structure workout may be updated according data from the equipment.

According to further embodiments, various systems, methods, and operations described above are implemented using a computer. For example, some embodiments provide for a computer program product comprising a computer useable storage medium having computer program code embodied therein, the computer program code configured to cause a computing device to operate in accordance with aspects of the invention as described herein.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a diagram illustrating an example health and fitness system which can implement or work in conjunction with a system in accordance with an embodiment of the invention.

FIGS. 2A & 2B are diagrams illustrating an example piece of fitness equipment used in conjunction an example health and fitness system in accordance with an embodiment of the invention.

FIG. 3 is a diagram illustrating an example piece of fitness equipment used in conjunction an example health and fitness system in accordance with an embodiment of the invention.

FIG. 4 is a diagram illustrating an example graphical representation of a structured workout and user interface according to one embodiment of the invention.

FIG. 5 is a diagram illustrating an example graphical representation of a structured workout and user interface according to one embodiment of the invention.

FIG. 6 is a flowchart of an example method in accordance with an embodiment of the invention.

FIG. 7 is a diagram illustrating an example computing module for implementing various embodiments of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward systems and methods for interfacing with fitness (i.e., exercise) equipment and tracking and managing health and fitness data, such physiological data. With respect to interfacing with fitness equipment, the systems and methods according to some embodiments are capable of communicating with fitness equipment such that data can be both sent to, and retrieved from, the equipment. For some such embodiments, the data sent to the fitness equipment may comprise a command, such as a command adjusting settings or operation of the fitness equipment. For an indoor cycle, the health and fitness system may send a command to the indoor cycle that adjusts the resistance of the indoor cycle. For data retrieved from fitness equipment, such retrieved data can include physiological data monitored and tracked by the fitness equipment's various physiological monitoring sensor (e.g., heart sensor), and data relating to settings and operation of the fitness equipment (e.g. resistance setting).

The health and fitness system may also provide a user interface (UI) configured with a graphical display that both provides data from the fitness equipment, and accepts user inputs that can be passed to the fitness equipment. Through such a user interface, a user can easily interface with fitness equipment that is compatible with embodiments of the present invention. For example, an embodiment may be configured with a user interface that allows a user to change settings of the fitness equipment through the health and fitness system, thereby obviating the need for the user to change settings through the central module on the fitness equipment. In addition, using its ability to interface with the fitness equipment, certain embodiments can upload settings and commands according to a workout plan residing on the health and fitness system. This not only allows a user to maintain a history of workouts performed and user's performance from such workouts, but provides portability of workouts and faster configuration of the fitness equipment.

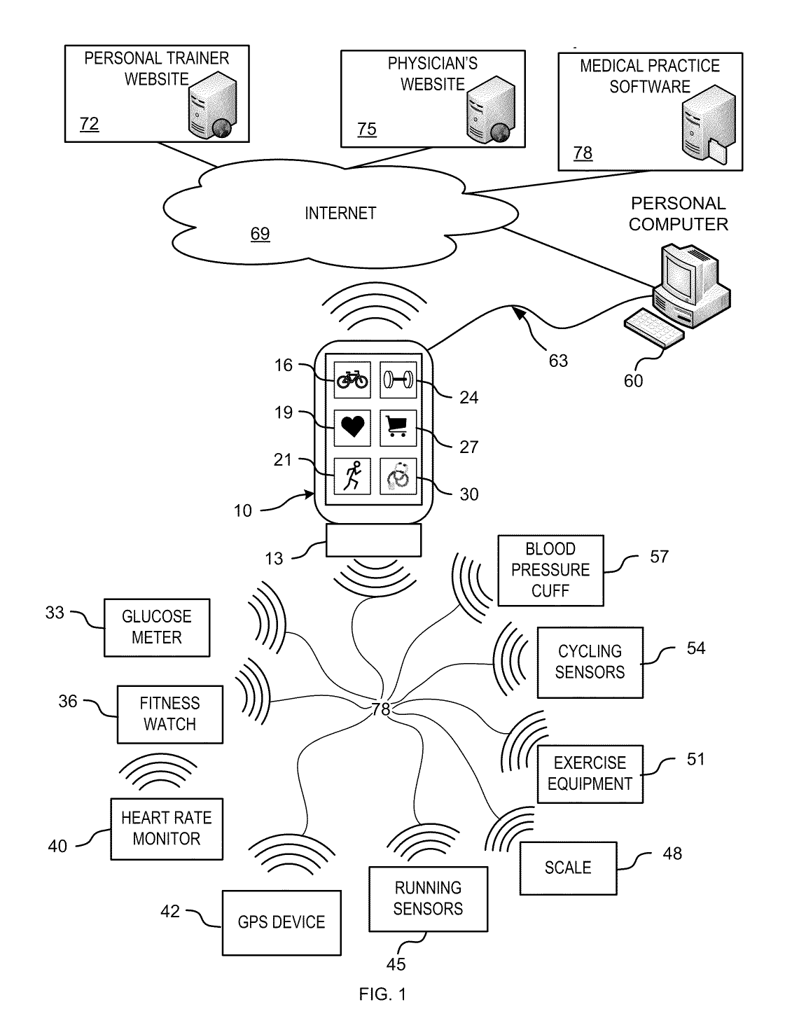

FIG. 1 is a diagram illustrating an example system of health and data retrieval, storage and management, which may implement or work in conjunction with the system in accordance with an embodiment of the present invention. Illustrated is a mobile computing device 10 equipped with a communications interface 13 that allows the device 10 to communicate with various health devices (33 through 57). In the illustrated embodiment, the device 10 is operating a health and fitness system. This system may also be referred to herein as a health and fitness ecosystem. Such an ecosystem is capable of not only integrating multiple health and fitness applications, and retrieving, storing and managing health and fitness data, but also implementing or working in conjunction with a health and fitness system according to the present invention.

The mobile computing device 10 may be equipped with a communications interface 13 that allows the device 10 to communicate with various health monitoring devices (e.g., fitness watch 36, running sensor 45, cycling sensor 54) or directly with various fitness equipment (i.e., equipment 51). Additional communication interfaces (not shown) allow the device 10 to communicate with an external computer network, such as the Internet 69. Examples of a mobile computing device may comprise a mobile phone, such as a smart phone, or a PDA, that has a data connection to the Internet 69 and the ability to load and execute computer programs via an operating system. For example, computing device 10 may comprise a smart phone running an operating system and may be programmed with a health and fitness system application that allows it to communicate with the health monitoring devices (33 through 57) and to allow physiological data collected from the health monitoring devices to be uploaded or synchronized to an external source, such as a website.

It should be noted that different health monitoring devices may be configured to communicate according to various protocols. For example, a cyclometer might be configured to wirelessly communicate according to an ultra low power protocol such as the ANT+ protocol, while a GPS device might be configured to wirelessly communicate according to the Bluetooth protocol. Accordingly, the communications module 76 may be configured to communicate according to a plurality of different communications protocols to provide the obtained data to the mobile device 75.

In the illustrated example, the health and fitness system operating on device 10 comprises applications that help store, track and manage data provided by specific types of fitness activities. Here the applications are a cycling application 16, a weight training application 24, a cardio application 19, and a running application 21. Other applications relating to specific fitness activities could include, without limitation, a yoga application, a hiking application, a Spinning® application, a Pilates application, a rowing application, and a walking application. Through some health and fitness systems in accordance with an embodiment, some such applications, such as the cardio application or Spinning® application, can transmit commands to fitness equipment, such as a treadmill or a Spinning® cycle respectively.

The illustrated system further comprises a store 27, which may allow a user to purchase health and fitness equipment, such as heart monitoring sensors, or health or fitness content such as a workout routine. Additionally, the system comprises a medical application 30, which can provide the user with health and medical information or advice. After reading the description provided herein, it will be apparent to one of ordinary skill in the art that a variety of applications relating to health and fitness could operate on health and fitness systems in accordance with the invention. Additionally, depending on the embodiment, the application may retrieve and store information locally on the mobile device 10, or on a remote computing device connected to the mobile computing device 10 through a network connection.

Through the illustrated system, a user may have access to a variety of health monitoring devices. For example, an athlete such as a runner may be equipped with a variety of data collecting devices during an period, such as a running sensor 45, a GPS device 42, a heart rate monitor 40, and a fitness watch 39. Various devices may be configured to temporarily store data during the period and then provide the system access to this data at a later point in time. For example, GPS device 42 may be configured to store a route taken by a runner during a run, and then to provide that route to the health fitness system at a later point in time. Furthermore, some health monitoring devices may be pre-configured to interoperate with each other before ultimate collection by the health and fitness system. For example, a fitness watch 36 may be configured to receive and collect data during an period from other health monitoring devices, such as heart rate monitor 40.

Other health and fitness devices that can provide the system with data include glucose meter monitor 33 and blood pressure monitor 57, both of which provide readings on body vitals, and a weight scale 48, which can provide the system with a user's weight. Additional equipment 51 may include sensors that supply physiological data to the illustrated system.

The illustrated system is further configured to interface with a personal trainer website 75, which provides the user of the mobile device 10 with personal fitness training via the health and fitness system, and a physician's website 75 through which the mobile device 10 may provide health and fitness information to the user's physician in almost real-time. Optionally, the system may be configured to interface with the medical practice software 78 providing an alternative means for presenting health and fitness information to the user's physician. The system may synchronize or upload health and system data with the user's personal computer 60, which may be facilitated through a direct connection 63 with the personal computer or through an Internet connection. The direct connection 63 may be a wired or wireless connection between the personal computer 60 and the mobile device 10.

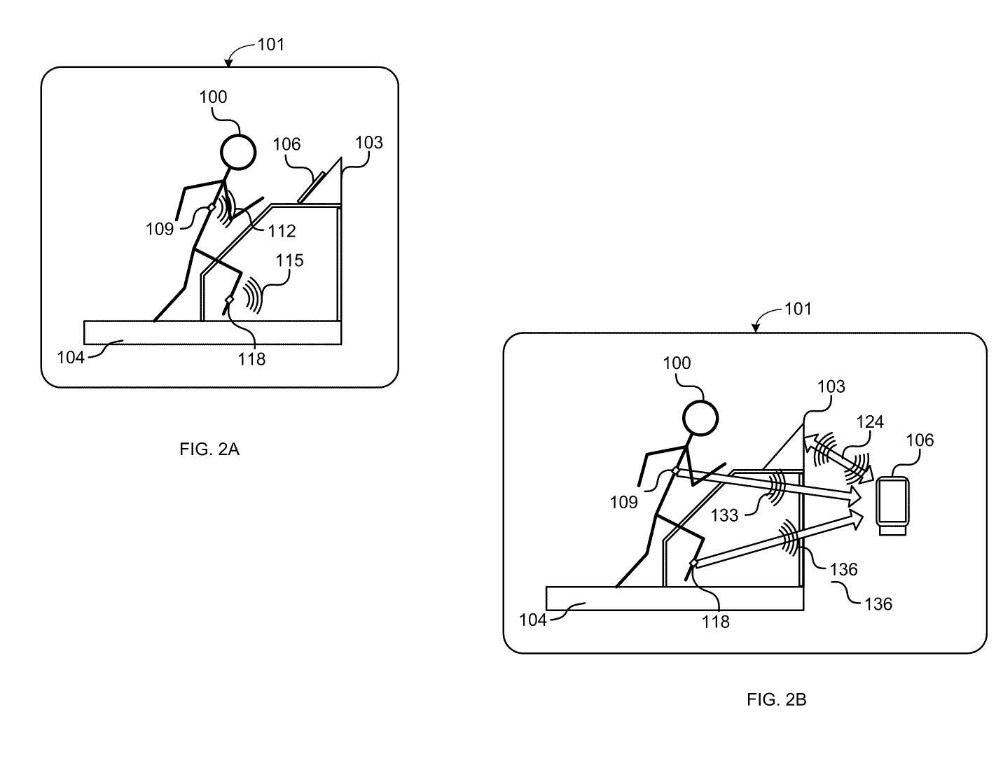

As noted earlier, methods and systems in accordance with embodiments of the invention may be used in conjunction with various pieces of exercise equipment, such as an cycle, a rowing machine, a treadmill, an elliptical trainer, or personal transportation devices, such as a power assisted bicycle. FIGS. 2A and 2B present an example environment 101 in which user 100 is utilizing a health and fitness system in accordance with an embodiment of the present invention. In particular, in example environment 101, a user 100 is utilizing a treadmill 104 equipped with a fitness computer 103, which controls such things as settings/parameters (e.g., speed and incline) and operation of the treadmill. Depending on the treadmill, the fitness computer may further be configured to collect health and fitness data from the user 100 as he or she operates the treadmill.

As illustrated in FIGS. 2A and 2B, the user 100 is employing a mobile computing device 106 while utilizing the treadmill 104, and the mobile computing device 106 is operating a health and fitness system in accordance with an embodiment of the invention. Additionally, the user 100 is equipped with a heart rate sensor 109 and a cadence sensor 118, which are used in conjunction with the health and fitness system operating on the mobile computing device 106 as illustrated in FIG. 2B. Specifically, mobile computing device 106 is in communication with the fitness computer 103 of the treadmill, heart rate sensor 109, and cadence sensor 118. Through this communication, the health and fitness system on computing device 106 can retrieve physiological data from the sensors (e.g., 109, 118), retrieve the treadmill's settings/parameters (e.g., speed, incline, etc.), and issue commands to operate and adjust the operation of the treadmill 104 (e.g., according to a structured workout, or according to physiological data).

Though some of the communications illustrated are bidirectional (e.g., 124) with the fitness computer 103, and others unidirectional (e.g., 133, 136) with the sensors, it would be well appreciated by those of ordinary skill in the art that sensor communication and fitness computer communication may be opposite in other embodiments (i.e., unidirectional communication with the fitness computer, and bidirectional communication with sensors), and not mutually exclusive. It should also be noted that those of ordinary skill in the art would appreciate that in addition to those sensors described herein, other health and fitness sensors may also be utilized in conjunction with health and fitness systems embodying the invention.

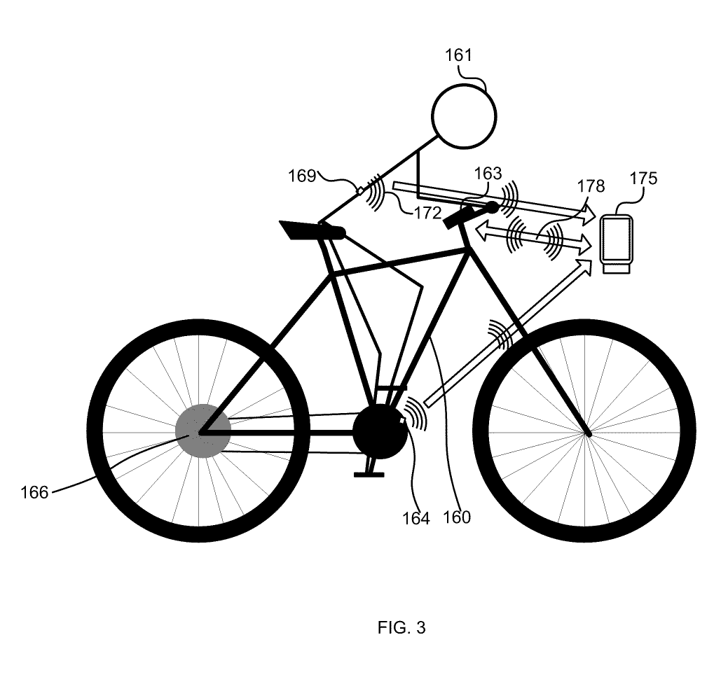

FIG. 3 is a diagram illustrating a power assisted bicycle 160 used in conjunction an example health and fitness system in accordance with an embodiment of the invention. As shown, the user 161 (i.e., rider) is operating the bicycle 160 with the health and fitness system running on the illustrated mobile computing device 175 (e.g., smart phone, tablet computer, etc.). The bicycle 160 is equipped with a motor 166 that assists the rider 161 in operating the bicycle, and a control module, machine control system 163, that controls the level of assistance provided by the motor 166, among other things. Also illustrated are sensors that provide physiological data to the machine control system 163, the mobile computing device 175, or both. For example, the rider is wearing a heart rate sensor 169, which wirelessly provides information to the mobile computing device 175, and a power sensor 164 attached to the bicycle drive train, which wirelessly provides information relating to the power produced by the rider 161 as he or she operates the bicycle 160.

As shown, the mobile computing device 175 has bi-directional communication 178 with the fitness computer 163, thereby allowing it to both wirelessly retrieve health and fitness data from the fitness computer 163, and transmit commands to the fitness computer 163. Through the commands transmitted to the fitness computer 163, the mobile computing device 175 is capable of controlling the operation and settings of motor 166. As previously described, in some embodiments this ability allows the health and fitness system running on the mobile computer device 175 to transmit commands to the fitness computer 163 based on physiological data the mobile computer device 175 collects, based on a structured workout plan residing on the mobile computer device 175, or based on some combination thereof.

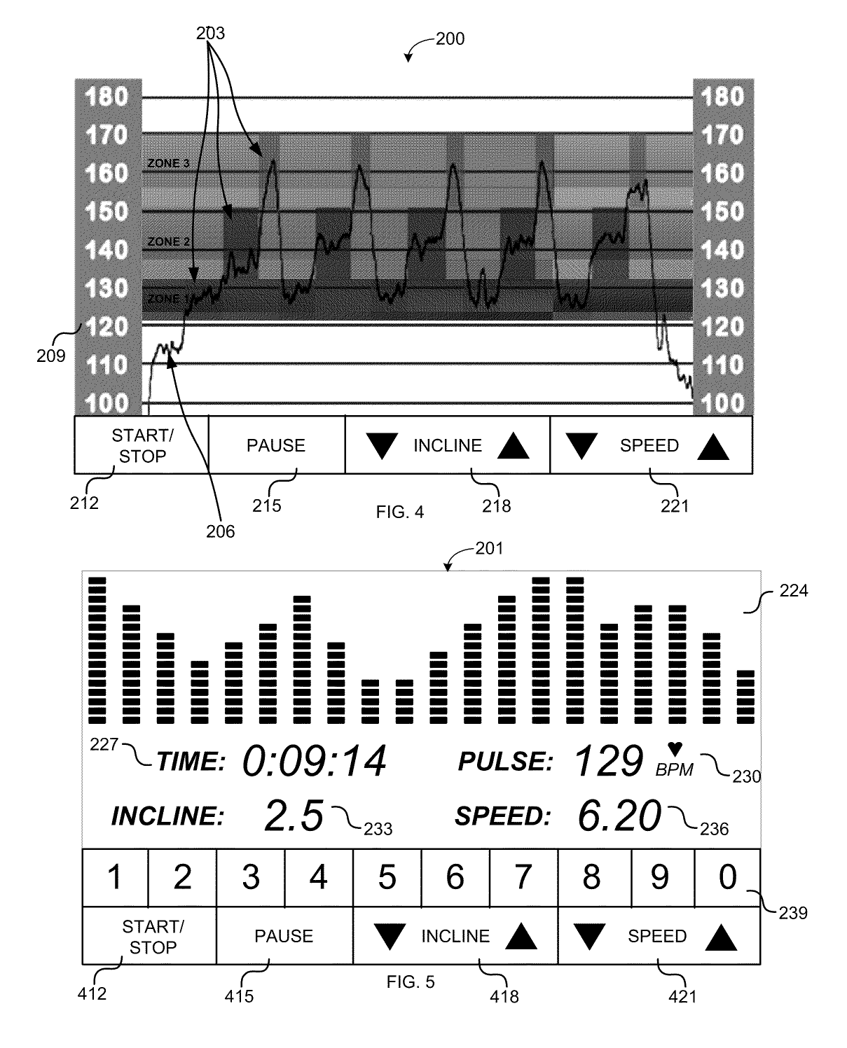

Turning now to FIGS. 4 and 5, provided are example graphical representations of a structured workout in conjunction with a user interface in accordance with some embodiments of the invention. In FIG. 4, health and fitness data is displayed as a trend line on the graphical representation. Specifically, FIG. 4 depicts a structured cardio vascular workout, with the vertical indicators 209 indicating heart rate per minute. Also depicted are optional graphical user interface buttons 212-221, which allow a user to start/stop 212 or pause 215 the structured work. Additionally, in some embodiments when the user presses the start/stop 212 or 215 buttons, the health and fitness system may send a corresponding command to the cardio fitness equipment (not shown) being used for the structured workout. Further, the incline button 218 and speed button 221 are provided and can be utilized by the user to instruct the health and fitness system to command the cardio fitness equipment to adjust its operation accordingly (i.e., increase or decrease the incline, or increase or decrease the speed of the equipment). With respect to the trend line 206, the position of the trend line 206 determines what the heart rate is at a given time during the structured workout. As the workout progresses (i.e., time elapses during the workout), the trend line scrolls across the structured workout graphical representation 200. Also depicted in FIG. 4 are shading indicators 203 that show which target heart zones 1-3 (i.e., zone 1, zone 2, zone 3) the trend line 206 is meeting at a given moment during the workout.

Referring now to FIG. 5, another example graphical representation 201 of a structured workout in conjunction with a user interface is provided. In some embodiments, graphic representation 201 is an alternative display of the same structured workout as FIG. 4. Like FIG. 4, the graphical representation 201 of FIG. 5 has optional graphical user interface buttons 412-421, which allow a user to start/stop 412 or pause 415 not only structured work, but the cardio fitness equipment as well through commands issued by the health and fitness system. Graphical representation 201 has additional numeral buttons 239 that allow the user to input numbers to be sent to the cardio fitness equipment. For example, some fitness equipment allows the user to input numbers to set the desired time duration for the workout, or to set the desired distance to be traveled during the workout. Also shown is a visual representation of the fitness equipment's speed or incline settings 224 over a period of time. Additionally, standard numerical data, such as time elapsed in the workout 227, pulse information from a heart rate sensor/monitor 230, current speed setting (i.e., parameter) of the equipment 236, and the current inclination of the equipment 233 are displayed.

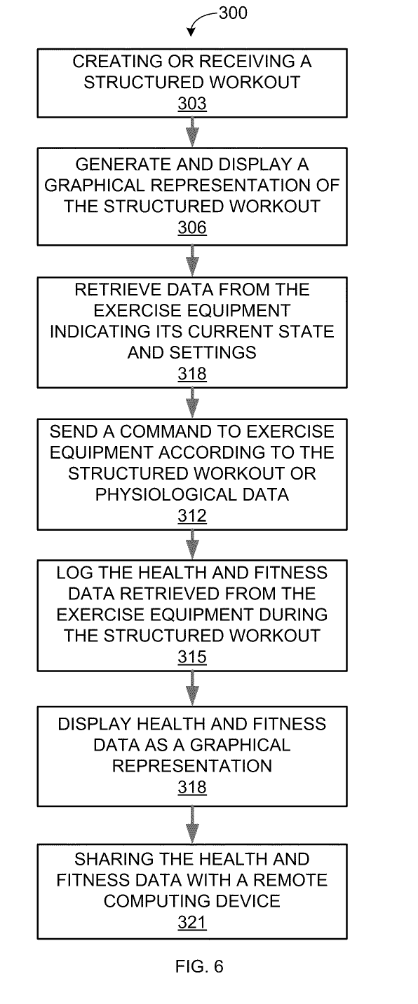

FIG. 6 is a flowchart of an example method 300 in accordance with an embodiment of the invention. According to some embodiments, the method 300 depicted may be used in conjunction with a mobile computing device. The method 300 begins at operation 303 with either the creation or reception of a structured workout. For example, the computing device performing the method 300 may receive the structured workout from a fitness website through a wireless network connection. In another example, a user may create a structured workout on the mobile computer device itself. As described earlier herein, the structured workout may be static or dynamic in nature. For example, where the structured workout is dynamic, the stages of the structured workout may change based on the performance of the user (i.e., based on physiological data of the user).

During operation 306, a graphical representation of the structured workout is generated and displayed. For example, where the method 300 is operating on a mobile computing device, the structured workout is generated into a graphical representation, which is then displayed on the mobile computer device's screen. Next, the method 300 retrieves data from the equipment currently being utilized (308). Depending on the embodiment, the data retrieved from the equipment may be the current state of operation and settings of the equipment. Then, based on the data retrieved, the structured workout, the health and fitness data (e.g., physiological data), or some combination thereof, the method 300 sends a command to the equipment at operation 312. Depending on the embodiment, the command may be to control the operation, settings of the equipment, or both.

As health and fitness data is retrieved from the equipment during the structured workout, the data is logged by the method 300 at operation 315. Then, at operation 318, the method 300 displays the health and fitness data collected as a graphical representation. In some embodiments, this graphical representation is displayed as an overlay over the structured workout of operation 306. Additionally, after displaying the health and fitness data as a graphical representation, the method 300 can optionally share the data with a remote computing device, such a website on the Internet (321).

The term tool can be used to refer to any apparatus configured to perform a recited function. For example, tools can include a collection of one or more modules and can also be comprised of hardware, software or a combination thereof. Thus, for example, a tool can be a collection of one or more software modules, hardware modules, software/hardware modules or any combination or permutation thereof. As another example, a tool can be a computing device or other appliance on which software runs or in which hardware is implemented.

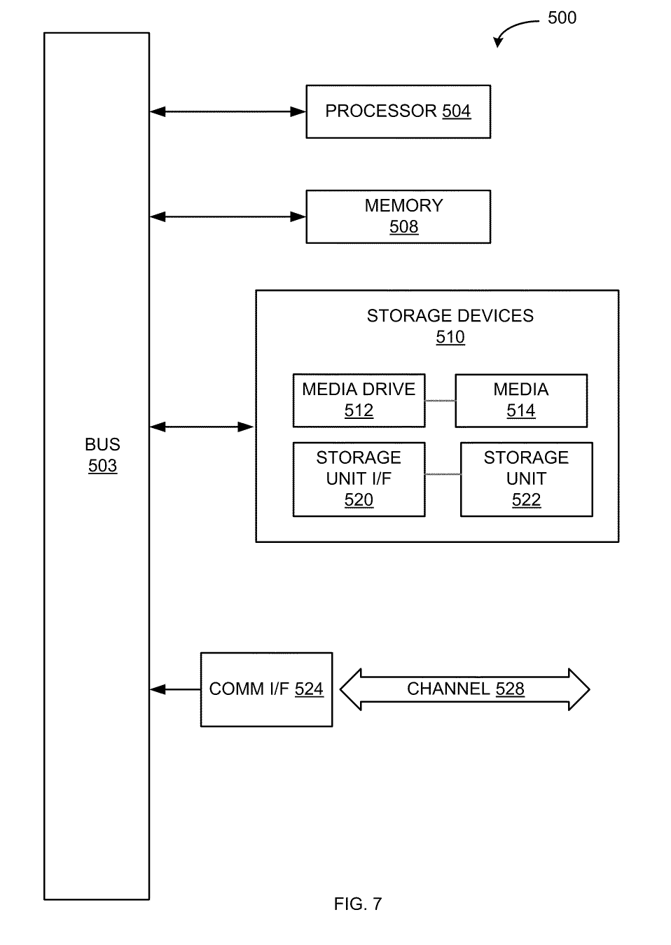

As used herein, the term module might describe a given unit of functionality that can be performed in accordance with one or more embodiments of the present invention. As used herein, a module might be implemented utilizing any form of hardware, software, or a combination thereof. For example, an appropriate combination of hardware, firmware and software, such as one or more processors, controllers, ASICs, PLAs, PALs, CPLDs, FPGAs, logical components, software routines, and other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 7. Various embodiments are described in terms of this example-computing module 500. After reading this description, it will become apparent to a person skilled in the relevant art how to implement the invention using other computing modules or architectures.

Referring now to FIG. 7, computing module 500 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 500 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 500 might include, for example, one or more processors, controllers, control modules, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of computing module 500 or to communicate externally.

Computing module 500 might also include one or more memory modules, simply referred to herein as main memory 508. For example, preferably random access memory (RAM) or other dynamic memory, might be used for storing information and instructions to be executed by processor 504. Main memory 508 might also be used for storing temporary variables or other intermediate information during execution of instructions to be executed by processor 504. Computing module 500 might likewise include a read only memory (“ROM”) or other static storage device, such as non-volatile memory (e.g., flash memory), coupled to bus 502 for storing static information and instructions for processor 504.

The computing module 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a flash memory drive, a floppy disk drive, a magnetic tape drive, an optical disk drive, a CD or DVD drive (R or RW), or other removable or fixed media drive might be provided. Accordingly, storage media 514 might include, for example, a hard disk, a a flash drive, floppy disk, magnetic tape, cartridge, optical disk, a CD or DVD, or other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing module 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory module) and memory slot, a PCMCIA slot and card, and other fixed or removable storage units 522 and interfaces 520 that allow software and data to be transferred from the storage unit 522 to computing module 500.

Computing module 500 might also include a communications interface 524. Communications interface 524 might be used to allow software and data to be transferred between computing module 500 and external devices. Examples of communications interface 524 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 524 might typically be carried on signals, which can be electronic, electromagnetic (which includes optical) or other signals capable of being exchanged by a given communications interface 524. These signals might be provided to communications interface 524 via a channel 528. This channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the foam of computer programs or other groupings). When executed, such instructions might enable the computing module 500 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perforin the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A health and fitness system for equipment configured for exercise or personal transportation, comprising:
a means for communicating with the equipment;
a means for retrieving data from the equipment;
a means for transmitting a command to the equipment; and
a means for providing a user interface for the equipment, the user interface comprising:
a graphical display for data provided by the equipment, and
a user input configured to accept a user selection, wherein the user selection is translated into a command and transmitted to the equipment.

2. The health and fitness system of claim 1, wherein the command comprises one for adjusting a setting of the equipment or one for controlling operation of the equipment.

3. The health and fitness system of claim 1, wherein the means for communicating with the equipment does so through a central module on the equipment.

4. The health and fitness system of claim 1, wherein the data from the equipment comprises data relating to operation of the equipment or data relating to a parameter of the equipment.

5. The health and fitness system of claim 1, wherein the data from the equipment comprises health and fitness data.

6. The health and fitness system of claim 5, further comprising a means for logging the health and fitness data.

7. The health and fitness system of claim 5, further comprising a means for retrieving health and fitness data from another health and fitness data source.

8. The health and fitness system of claim 5, wherein the health and fitness data includes physiological data and exercise session data.

9. The health and fitness system of claim 8, wherein the physiological data includes heart rate, cadence, blood pressure, respiration, body temperature, body position, body motion, speed, acceleration, and power output.

10. The health and fitness system of claim 5, further comprising a means for sharing the health and fitness data with a remote computing device or database on a server.

11. The health and fitness system of claim 10, wherein the means for sharing health and fitness data includes interacting with a personal trainer website, a medical website, or a practice management software.

12. The health and fitness system of claim 10, wherein the remote computing device is on the Internet.

13. The health and fitness system of claim 1, wherein the means for communicating with the equipment computer does so through a sensor attached to the equipment.

14. The health and fitness system of claim 1, wherein the equipment is an cycle, a rowing machine, a treadmill, an elliptical trainer, or a power assisted bicycle.

15. The health and fitness system of claim 1, further comprising a means for creating or receiving a structured workout.

16. The health and fitness system of claim 15, wherein the health and fitness system transmits commands to the equipment according to the structured workout.

17. The health and fitness system of claim 15, further comprising a means for generating a graphical representation of the structured workout.

18. The health and fitness system of claim 17, wherein the graphical representation of the structured workout is updated according data from the equipment.

19. The health and fitness system of claim 1, wherein the means for transmitting the command to the equipment transmits the command according to health and fitness data.

20. A computer program product comprising a computer useable storage medium having computer program code embodied therein, the computer program code configured to cause a computing device to:
communicate with equipment configured for or personal transportation;
retrieve data from the equipment;
transmit a command to the equipment; and
provide a user interface for the equipment, the user interface comprising:
a graphical display for data provided by the equipment, and
a user input configured to accept a user selection, wherein the user selection is translated into a command and transmitted to the equipment.

21. The computer program product of claim 1, wherein the command comprises one for adjusting a setting of the equipment or one for controlling operation of the equipment.

22. The computer program product of claim 1, wherein the command comprises one for adjusting a setting of the equipment or one for controlling operation of the equipment.

23. The computer program product of claim 1, wherein the computing device communicates with the equipment computer through a central module on the equipment.

24. The computer program product of claim 1, wherein the data from the equipment comprises data relating to operation of the equipment or data relating to a parameter of the equipment.

25. The computer program product of claim 1, wherein the data from the equipment comprises health and fitness data.

26. The computer program product of claim 25, wherein the computing device further logs the health and fitness data.

27. The computer program product of claim 5, the computing device further retrieves health and fitness data from another health and fitness data source.

28. The computer program product of claim 5, wherein the health and fitness data includes physiological data and exercise session data.

29. The computer program product of claim 28, wherein the physiological data includes heart rate, cadence, blood pressure, respiration, body temperature, body position, body motion, speed, acceleration, and power output.

30. The computer program product of claim 5, further the computing device further shares the health and fitness data with a remote computing device or database on a server.

31. The computer program product of claim 30, wherein to share health and fitness data the computing device interacts with a personal trainer website, a medical website, or a practice management software.

32. The computer program product of claim 30, wherein the remote computing device is on the Internet.

33. The computer program product of claim 1, wherein the computing device communicates with the equipment computer through a sensor attached to the equipment.

34. The computer program product of claim 1, wherein the equipment is an cycle, a rowing machine, a treadmill, an elliptical trainer, or a power assisted bicycle.

35. The computer program product of claim 1, wherein the computer device further creates or receives a structured workout.

36. The computer program product of claim 35, wherein the computing device further transmits commands to the equipment according to the structured workout.

37. The computer program product of claim 35, wherein the computing device further generates a second graphical representation of the structured workout.

38. The computer program product of claim 37, wherein the first graphical representation of the structured workout is updated according data from the equipment.

39. The computer program product of claim 1, wherein the computing device transmits the command to the equipment according to health and fitness data.
